(19) United States
(12) Patent Application Publication
(10) Pub. No.: US 2025/0372853 A1
(43) Pub. Date: Dec. 4, 2025

(54) OMNIDIRECTIONAL RESONATOR COMBLINE WAVEGUIDE FILTER

(71) Applicant: SWISSto12 SA, Renens (CH)

(72) Inventors: Esteban MENARGUES GOMEZ, Préverenges (CH); Santiago CAPDEVILA CASCANTE, Renens (CH); Stefano SIRCI, Lausanne (CH)

(21) Appl. No.: 18/870,796

(22) PCT Filed: Jun. 1, 2023
(86) PCT No.: PCT/IB2023/055638

§ 371 Date: Dec. 2, 2024

(30) Foreign Application Priority Data
Jun. 2, 2022 (CH) 20220000673

(51) Int. Cl. H01P 1/205; B33Y 10/00; B33Y 80/00; H01P 11/00

(52) U.S. Cl. CPC H01P 1/2053; B33Y 10/00; B33Y 80/00; H01P 11/002

(57) ABSTRACT

The present disclosure relates to a combline waveguide filter obtained by metal additive manufacturing, having at least two resonators connected together by main irises, each resonator having a cavity with a first axis, each cavity being delimited in particular by a flat base extending perpendicularly to the first axis. Each cavity is further delimited by a roof converging towards a single point. The present disclosure also relates to a method of manufacturing a combline waveguide filter as described, the method including the additive manufacture of the at least two resonators and the main irises connecting the resonators.

### TECHNICAL BACKGROUND

The present invention relates to a combline waveguide filter with omnidirectional resonators obtained by additive manufacturing.

### STATE OF THE ART

Radio frequency (RF) signals can propagate either in free space or in waveguide devices.

An example of such a conventional waveguide is described in patent application WO2017208153, the contents of which are incorporated by reference. It consists of a hollow device, the shape and proportions of which determine the propagation characteristics for a given wavelength of the electromagnetic signal. The cross-section of the internal channel of this device is rectangular. Other channel cross-sections are suggested in this document, including circular shapes.

The waveguide of this prior art comprises a core produced by additive manufacturing by superimposing layers one on top of the other. This core defines an internal channel for guiding waves, the cross-section of which is determined by the frequency of the electromagnetic signal to be transmitted. The inner surface of the core is covered with a conductive metal layer. The outer surface may also be covered with a conductive metal layer which contributes to the rigidity of the device.

Waveguide devices are used to channel RF signals or to manipulate them in the spatial or frequency domain, for example to form a waveguide filter. The present invention relates in particular to passive waveguide filters which allow RF signals to be filtered without the use of active electronic components.

Conventional waveguide filters used for radio frequency signals generally have internal apertures of rectangular or circular cross-section. The primary purpose of these filters is to suppress unwanted frequencies and pass the desired frequencies with minimum attenuation. Attenuations in excess of 100 dB or even 120 dB may be required for filters intended for reception and/or transmission systems in the space domain, for example.

Compact, lightweight waveguide filters are also required for space and aeronautical applications. Consequently, major research efforts have been made to propose waveguide filter geometries that meet these different objectives.

For example, evanescent mode filters or combline filters are known. They are essentially made up of several small cavities (below the dimension corresponding to the cut-off frequency) which transmit electromagnetic energy between an input port and an output port. The successive cavities are connected by irises, the dimensions of which help to determine the filter's bandwidth. Several crests or posts allow the fundamental mode to propagate. This type of filter is used, for example, for the input and output stages of satellite payloads, because of their high selectivity and reduced weight and size.

Conventional combline waveguide filters are made by machining and assembling various metal sub-assemblies. These operations are complex and costly. Moreover, filters made in this way weigh a lot.

Furthermore, the geometries of conventional combline waveguide filters are often limited because the resonant cavities (or resonators) and the irises connecting the resonant cavities are designed in such a way that they have to be arranged consecutively along an axis of propagation of the electromagnetic wave. This axial configuration makes combline waveguide filters cumbersome because they can be very long. In addition, the frequency ranges filtered are limited by the axial configuration since only successive cavities are connected by irises.

### BRIEF SUMMARY OF THE INVENTION

One aim of the present invention is to provide a combline waveguide filter free from the limitations of known waveguide filters.

Another aim of the invention is to provide a combline waveguide filter suitable for additive manufacturing.

Another aim of the invention is to provide a combline waveguide filter that is more compact and less bulky.

Another aim of the invention is to provide a combline waveguide filter that can filter wider frequency ranges.

According to the invention, these aims are achieved in particular by means of a combline waveguide filter obtained by metal additive manufacturing, comprising at least two resonators connected together by main irises,
each resonator comprising a cavity with a first axis,
each cavity being delimited in particular by a flat base extending perpendicularly to the first axis,
   characterized in that each cavity is further delimited by a roof converging towards a single point.

The fact that the resonators have a roof converging towards a single point makes additive manufacturing of the waveguide filter easier, or even possible, by avoiding cantilevered portions that are complex to manufacture. Secondly, the fact that the roof converges towards a single point means that the “axial” nature of traditional filters, in which the geometry of the resonators is constrained in the direction of propagation of the electromagnetic signal in the filter, is avoided.

Each roof can comprise a first lateral portion adjacent and perpendicular to the flat base and a second lateral portion converging towards the single point.

Each resonator can have a rotational symmetry about the first axis.

Each flat base can be circular or polygonal with at least three sides, preferably circular, square, pentagonal, hexagonal or octagonal.

Each resonator may further comprise a post rising from the planar base parallel to the first axis.

At least one post can be formed integrally with the flat base of a resonator.

A resonator's post may have a circular or polygonal with at least three sides cross-section, preferably a circular, square, pentagonal, hexagonal or octagonal cross-section.

Advantageously, the resonator post can be helical and extend along the first axis. This configuration makes it possible to increase the length of the post and therefore to allow greater adaptation of the impedance of the resonator cavity.

In one embodiment, the diameter of a helical post can be variable along the first z axis.

The roof of at least one resonator may comprise a projecting portion extending into the cavity of the at least one resonator parallel to the first axis.

At least one main iris may comprise a connection portion non-parallel to the flat base, the connection portion extending between two resonators connected by the at least one main iris.

The connection portion may connect said single points of the resonators connected by said at least one main iris.

At least one resonator may comprise several main irises which are not arranged coaxially.

The waveguide filter may comprise at least three resonators connected consecutively by said main irises, a first and a second resonator being connected together by a secondary iris.

This cross-coupling (in French “couplage croisé”) of resonators allows to improve the filter's selectivity in certain frequency ranges.

The secondary irises can have a different cross-section from the main irises in order to filter different frequency ranges, for example.

At least one said secondary iris may comprise a secondary connection portion extending between the resonators connected by the at least one said secondary iris.

The main irises of the resonators are arranged coaxially along an electromagnetic signal propagation axis.

The waveguide filter may comprise at least four resonators, one of the at least four resonators being connected to at least three separate resonators.

In particular, this feature makes it possible to obtain a filter combining the functions of filter and power divider and/or polarizer, for example.

At least one resonator may comprise a polarizer and/or a septum.

According to the invention, these aims are also achieved by means of a method of manufacturing a combline waveguide filter having at least one of the characteristics described above, the method comprising the additive manufacturing of the at least two resonators and the main irises connecting the resonators.

### BRIEF DESCRIPTION OF THE FIGURES

Examples of implementation of the invention are shown in the description illustrated by the attached figures in which:

FIGS. 1a-1f illustrate several possible geometries for the combline filter resonators.

FIG. 2a shows a combline filter in which the resonators connected by irises have a square base and are arranged in a line.

FIG. 2b shows a combline filter in which the resonators connected by irises have a square base and are arranged in a matrix.

FIGS. 3a and 3b show a perspective view and a top view of a combline filter in which the resonators have a circular base and are arranged in a staggered pattern.

FIGS. 4a-4e illustrate several possible geometries for a post in the cavity of a resonator having a circular base.

FIGS. 5a and 5b show a side view and a top view of a combline filter in which the square-based resonators are arranged in a matrix and the first and last resonators are connected by a secondary iris.

FIG. 6a shows a top view of a combline filter comprising a resonator connected to three other resonators.

FIG. 6b shows a top view of a combline filter comprising two resonators connected to three other resonators.

FIG. 7 shows a profile view of a resonator comprising a helical post.

FIG. 8 shows a top view of a resonator comprising a helical post.

FIG. 9 shows a top view of a combline filter comprising two resonators, each with a helical post.

### EXAMPLE(S) OF EMBODIMENT OF THE INVENTION

The present invention relates to a combline waveguide filter 1 obtained by additive manufacturing and comprising at least two resonators 2 connected together by main irises 24. Each resonator 2 comprises a cavity 20 delimited in particular by a flat base 21 perpendicular to a first axis z and by a roof 22. The roof 22 is characterized by the fact that it converges towards a single point 23, also known as the zenith point. In other words, each resonator 2 is provided with a pointed roof 22.

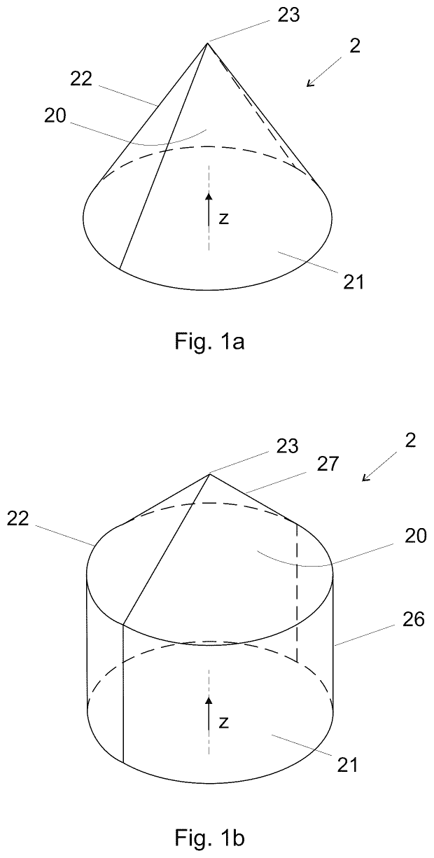

FIGS. 1a-1f show examples of resonators 2 that can be used in a combline waveguide filter 1 according to the present invention. The main irises 24 connecting the resonators are not shown in these figures.

The first z axis generally corresponds to the direction of additive manufacturing.

The convergence of the roof 22 of each resonator 2 towards a single point 23 allows to avoid cantilevered faces with respect to the first axis z, which are difficult or even impossible to produce by additive manufacturing. Furthermore, the manufacturing of a roof 22 converging toward a zenith point and not toward a roof's ridge, makes it possible to obtain a resonator 2 without a preferred direction of propagation of an electromagnetic wave. Indeed, a two-sided roof meeting at a ridge determines the direction of propagation to some extent, whereas a roof in accordance with the invention converging towards a single point allows greater leeway in choosing the direction of wave propagation in the waveguide filter. In other words, the resonators are omnidirectional in the sense that they can be connected to other resonators in almost any direction. The flexibility conferred by the geometry of the roof 22 according to the invention makes it possible, for example, to create a combline waveguide filter whose resonators are not aligned along an axis, but can form bends. It is thus possible to greatly reduce the overall dimensions of such filters by choosing geometries adapted to the particular constraints.

The roof 22 of a resonator 2 may be inclined away from the flat base 21 as shown in FIGS. 1a, 1c and 1e. Alternatively, the roof 22 may comprise a first lateral portion 26 adjacent and perpendicular to the flat base 21, and a second lateral portion 27 inclined and converging towards the single point 23 as illustrated in FIGS. 1b, 1d and 1f. In this way, the roof 22 can be designed as a pyramid with the flat base 21 as its base or as a combination of a right prism on the flat base 21 and a pyramid arranged on the prism.

Other embodiments include resonators having a roof 22 converging toward a single point 23, the profile of which is not linear as in the case of a pyramid, but is for example polygonal, parabolic, hyperbolic or any other profile making additive manufacturing possible.

Generally speaking, the angle formed by an inclined portion of the roof 22 with the first axis is between 10° and 60°, preferably between 25° and 50°, as too large an angle makes additive manufacturing of inclined portions difficult.

As illustrated in FIGS. 1a-1f, the resonators may have at least one rotational symmetry around the first z axis. Preferably, the resonators have several rotational symmetries about the first z axis.

FIGS. 1a and 1b show embodiments in which the roof 22 is conical or consists of a cone surmounting a cylinder. In these cases, maximum rotational symmetry is achieved because the roof profile is obtained as a surface of revolution about the first axis z.

FIGS. 1c and 1d illustrate embodiments in which the roof 22 is a square-based pyramid or consists of a square-based pyramid on top of a square-based prism (i.e. a parallelepiped). Thus roof 22 is invariant to rotations about the first axis z of angles kx90°, where k is an integer.

FIGS. 1e and 1f illustrate embodiments in which the roof 22 is a pyramid whose base is a regular hexagon or consists of a pyramid with a regular hexagonal base surmounting a prism with a regular hexagonal base. The roof 22 is thus invariant to rotations about the first axis z through angles kx60°, where k is an integer.

More generally, the roof 22 may comprise any surface of revolution about the first axis z, provided that this results in a roof converging towards a single point 23. Complementarily or alternatively, the roof 22 may comprise a pyramid whose base is formed by any polygon.

The first lateral portion 26 of the roof 22 may be cylindrical. Alternatively or complementarily, it may comprise a right prism whose base is any polygon.

In a preferred embodiment, the flat base 21 delimiting the cavity 20 of a resonator 2 according to the invention has the same characteristics of invariance by rotation about the first axis z as the roof 22. In particular, the flat base may be circular, polygonal with at least three sides, preferably circular, square, pentagonal, hexagonal or octagonal. Other geometries of the flat base 21, such as an ellipse or non-convex surfaces, can be envisaged without departing from the scope of the present invention.

The resonators 2 of a combline waveguide filter according to the present invention are interconnected by main irises 24. As explained below, some resonators may be provided with secondary irises, which explains the terminology “main” iris. These main irises 24 allow the propagation of an electromagnetic wave in the filter from one resonator to another.

In an embodiment in which two consecutive resonators 2 of the filter 1 have a geometry enabling them to be arranged against each other in sufficient proportion, i.e. a significant portion of the roof 22 of the first resonator is arranged against a significant portion of the roof 22 of the second resonator, a main iris 24 may consist of an opening in the contiguous portions of the roofs.

The cross-section of this opening determines the cut-off frequencies of the wave propagated between these two resonators via the main iris 24. This cross-section is therefore adapted to the particular requirements for which the filter 1 is intended.

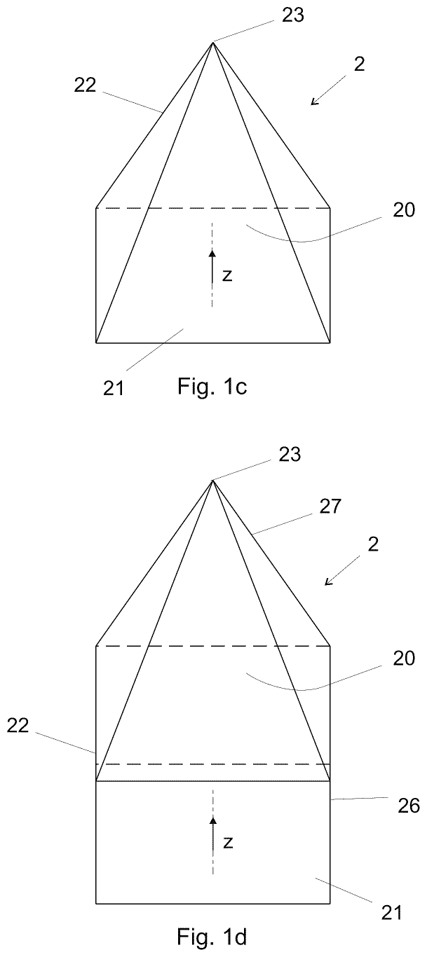

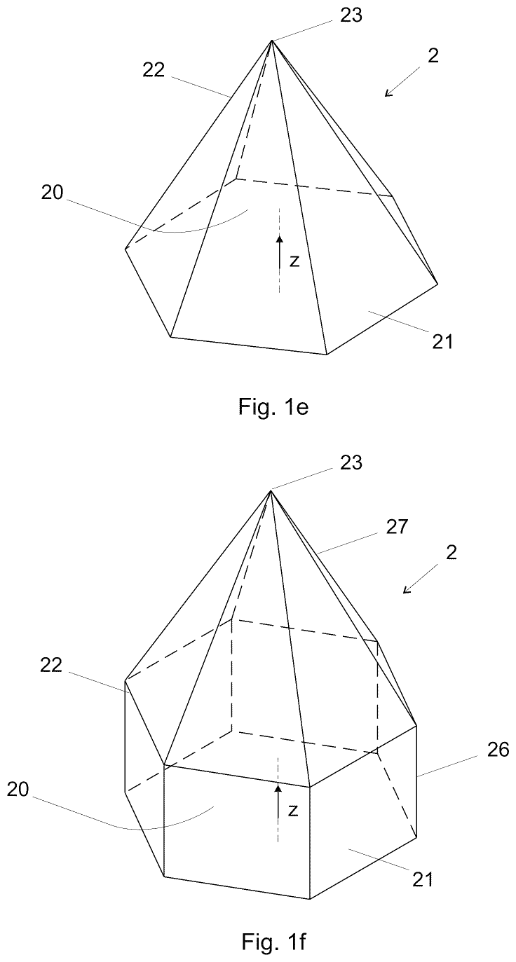

In another embodiment, the geometry of the resonators 2 requires a larger opening than the contiguous portions of the resonators. As illustrated in FIGS. 2a and 2b, the main iris 24 thus comprises an opening extending over the first lateral portion 26 of the roof 22 as well as over the second lateral portion 27. A connection portion 25 extends between at least part of the two second lateral portions 27 of the two roofs 22 of the resonators connected by the main iris 24.

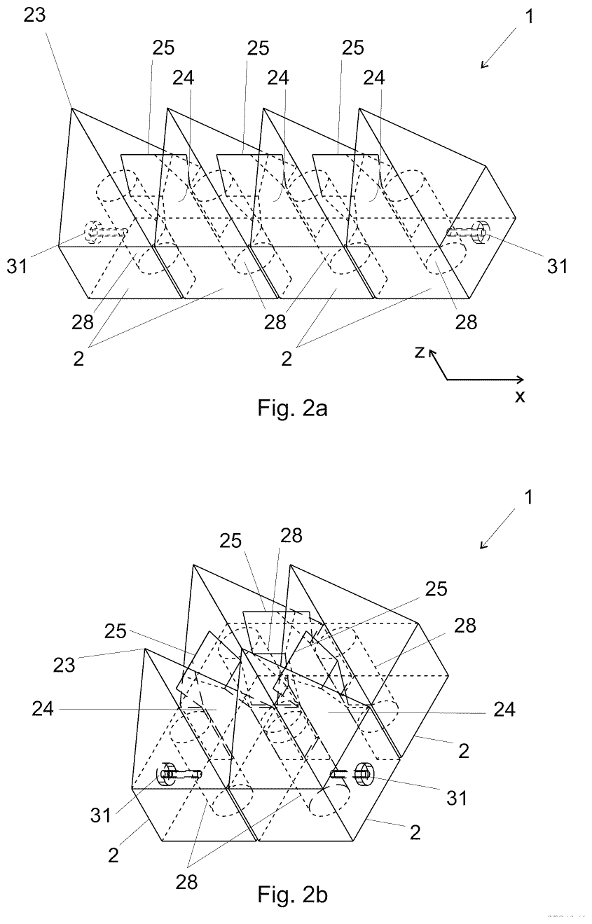

As illustrated in FIGS. 2a and 3a, the connection portions between the resonators may comprise inclined parts so as to facilitate, or even make possible, their additive manufacturing. The connection portions may, for example, consist of a gable roof.

In one embodiment, the connecting portions 25 can connect two roofs 22 over the entire height of the roofs or over the entire height of the second lateral portion 27 of the roofs. Alternatively or complementarily, the single points 23 of the two roofs 22 can be connected by a connection portion 25.

In an embodiment not shown, the geometry of the resonators 2 does not allow them to be arranged contiguously. Thus, a main iris 24 connecting two such resonators comprises a connection portion 25 connecting the two resonators. This connection portion can be, for example, a rectangular waveguide with the same cross-section as the openings in the main iris determining the cut-off frequencies.

Generally speaking, the length, width and height of the main irises and connection portions influence the level of coupling between two resonators. These parameters are therefore adapted according to requirements.

As illustrated in FIGS. 2a and 2b, the cavities 20 of the resonators 2 may include a post 28 rising from the flat base 21 parallel to the first axis z. The use of a post 28 in cavity 20 allows the impedance of the cavity to be modified, and thus the resonant frequency of the circuit formed by cavity 20 and main iris 24 to be controlled.

These posts 28 differ from any adjustment screws in that they do not allow the resonant frequency to be adapted or modified subsequently.

These posts 28 can be formed in one piece with the flat base 21. This method is advantageous in terms of additive manufacturing as it avoids any subsequent machining to form such a post.

The shape of these posts, and more particularly their cross-section in a plane parallel to the flat base 21, can be adapted as required and as a function of the geometry of the roof 22. The cross-sectional geometry of a post 28 is not necessarily the same as that of the flat base 21 or that of the roof 22 of the resonator in question.

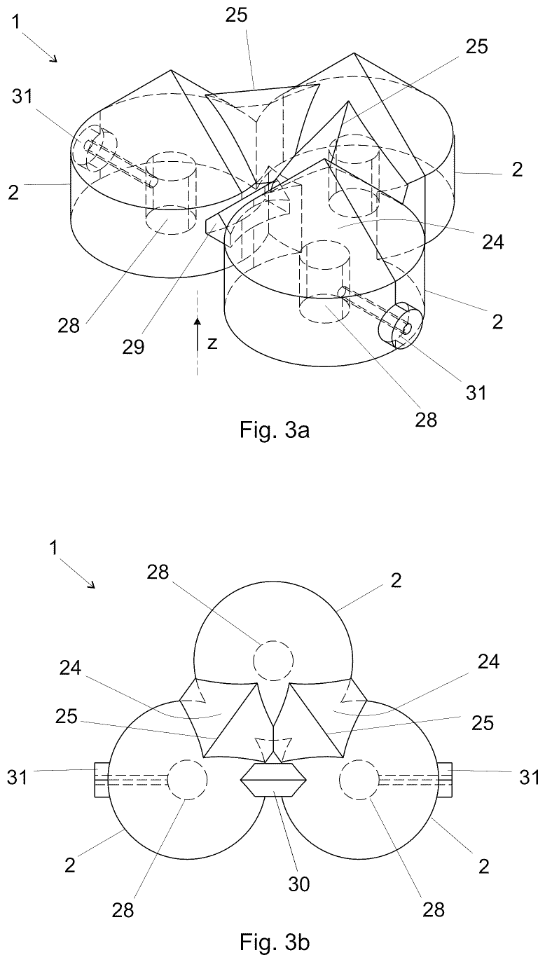

As illustrated in FIGS. 4a to 4e, a resonator 2 may comprise a post 28 whose cross-section is a right prism whose base is a circle or a polygon with at least three sides. Preferably, the base of the prism is circular, square, pentagonal, hexagonal or octagonal. The circular geometry of the flat base 21 and roof 22 in FIGS. 4a to 4e is by no means restrictive and all the alternative geometries mentioned above can be achieved in combination with these posts.

In order to facilitate the additive manufacturing of such a post 28, the upper face of the post, i.e. the face opposite the flat base 21, may comprise curved or inclined parts. These curved parts are also useful when the filter is intended for high-power applications.

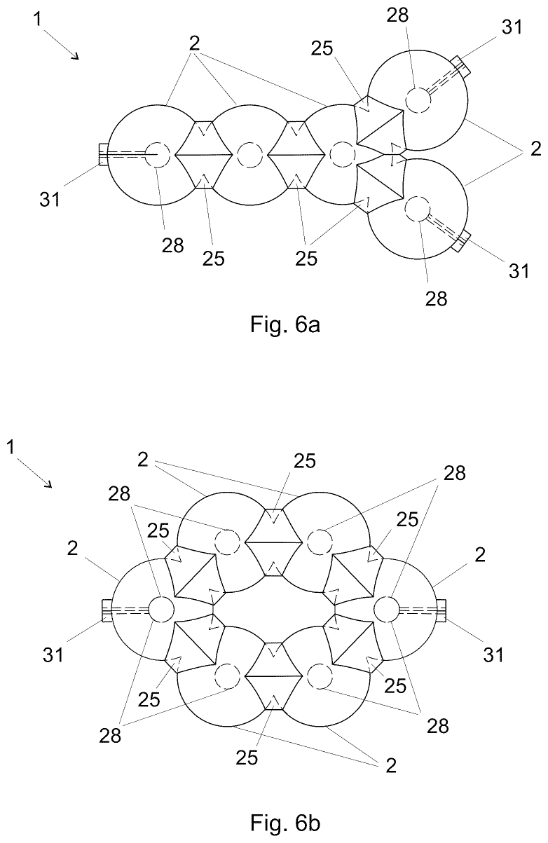

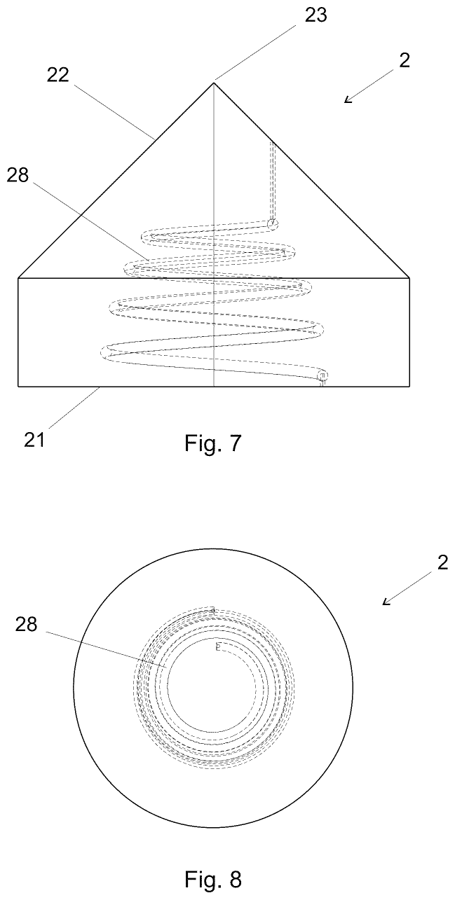

In an alternative embodiment illustrated in FIGS. 7 to 9, the post 28 takes the form of a helix whose main direction coincides with the first z axis. When it is said that a helical post extends parallel to an axis, it is meant that the main direction of the helix is parallel to said axis.

The use of such a helical post advantageously makes it possible to obtain a post 28 of greater length than that of a straight post. In particular, this allows greater adaptation of the impedance of the cavity 20.

The pitch of the propeller, i.e. the vertical distance between two consecutive points on the propeller in a plane including the first z axis, can be constant or variable.

The diameter of the helix may also be constant or variable. In a preferred embodiment illustrated in FIGS. 7 to 9, the diameter of the helix decreases as a function of the height in relation to the flat base 21 of the resonator 2. In particular, this configuration makes it possible to adapt the external diameter of the helical post to the internal diameter of the cavity 20 of the resonator 2. The surface of revolution on which the helix is formed is a cone.

However, in certain configurations where the diameter of the helix does not need to be reduced, it can be kept constant to further increase the overall length of the helical post.

Alternatively or complementarily, the surface of revolution on which the propeller rests can be an inverted cone, a cylinder, a sphere, or even a surface whose curvature is alternately positive and negative, so that the diameter of the propeller can be alternately increasing and decreasing.

Such a helical post 28 can be additively manufactured in one piece with the rest of the resonator. Alternatively or additionally, the helical post can be made separately from the resonator and placed in the cavity during or after the additive manufacture of the resonator.

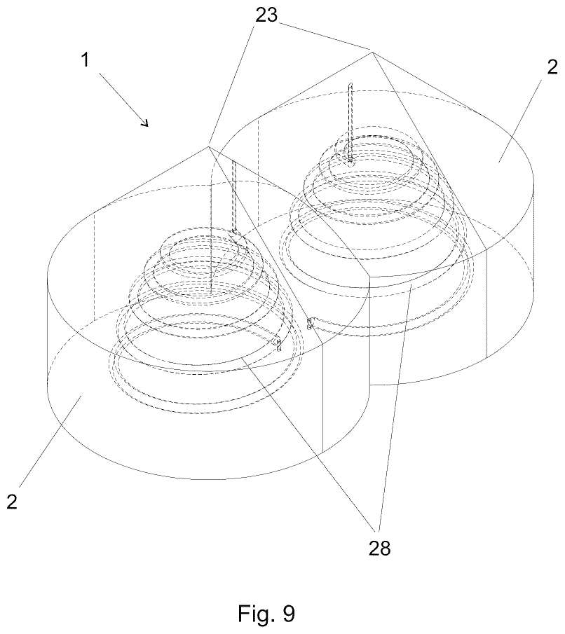

As illustrated in FIG. 9, two adjacent resonators 2 may each comprise a helical post 28. The orientation, i.e. the direction of winding of the helices may be the same or alternatively reversed.

The upper part of the cavity 20 of the resonators 2 may also be provided with projections extending from the inner surface of the roof 22 towards the interior of the cavity so as to modify the impedance of the cavity. These projections extend substantially parallel to the first axis. These projections are integral with the resonators and are thus also to be distinguished from conventional tuning screws which are movable elements with respect to the resonators.

In a preferred embodiment, the projecting parts are in one piece with the roof 22 of the resonator. In a similar way to the posts 28, the face of the projecting part opposite the roof 22 can be flat or curved according to particular requirements, particularly with regard to additive manufacturing and high-power use of the filter.

The resonators 2 of the waveguide filter 1 may include tuning screws allowing fine adjustments to be made when the filter is in use. Unlike the posts 28, these screws are movable elements in relation to the resonator structure and are used to make slight changes to the impedance of the resonator cavities 20.

As mentioned above, one of the main advantages of the waveguide filter according to the present invention lies in the omnidirectional nature of the resonators in the sense that they can be connected together non-coaxially, i.e. not necessarily along one axis.

FIGS. 3a and 3b illustrate an embodiment in which several resonators 2 are arranged non-coaxially. More specifically, a first resonator 2, for example the resonator on the left of FIG. 3a, has a port 31 enabling it to receive an electromagnetic signal at the input of the filter. This first resonator is connected to a second resonator 2 by a main iris 24 which comprises a connection portion 25. The main iris 24 is not diametrically opposed to the port 31. The straight lines passing, on the one hand, through port 31 and the center of the flat base 21 and, on the other hand, through the center of the flat base and the main iris 24 are intersecting and form an angle of between 90° and 150°.

The second resonator is itself also connected to a third resonator 2, the rightmost in FIG. 3a, via a main iris 24 also comprising a connection portion 25. The third resonator comprises a port 31 allowing the electromagnetic signal to exit the filter 1. In a similar way, the angle formed by the straight lines passing, on the one hand, through the main iris 24 connecting the second to the third resonator and the center of the flat base 21 and, on the other hand, through the center of the flat base and the port 31 are secant and form an angle of between 90° and 150°.

The filter obtained by this arrangement of resonators therefore forms a bend at the second resonator, which makes it possible to significantly reduce the total length of the filter for a given number of resonators compared with a traditional coaxial arrangement.

The circular geometry of the roof 22 of the resonators in this design allows great freedom in the relative positioning of the resonators with respect to each other. Indeed, it is virtually possible to place a circular resonator in any position around another circular resonator thanks to their invariance by rotation about the first z axis. A very wide variety of filter geometries can therefore be obtained by linking resonators in this way.

Another advantage resulting from the omnidirectional nature of the resonators lies in the fact that, thanks to the introduction of “elbows” in the filter, certain non-consecutive resonators, in the sense that they are not connected by a main iris, can be arranged very close together. In FIG. 3b, the two resonators each comprising a port 31 are not connected by a main iris but are nevertheless very close to each other. It is therefore possible to introduce secondary coupling between non-consecutive resonators by virtue of their proximity.

In particular, these secondary couplings make it possible to introduce alternative propagation paths for a wave inside the filter. Depending on the phase of the signal, the resulting effect of multiplying the paths for the wave in the filter can be the appearance of transmission zeros in the transfer function of the filter. This means that secondary coupling between non-consecutive resonators can be applied, for example, to achieve a linear phase response or to generate finite transmission zeros to improve the selectivity of the filter by increasing the filtering of particular frequencies at particular locations. In this way, the introduction of transmission zeros into the frequency response reduces the number of resonators required to meet a certain filter selectivity specification. The result is a reduction in insertion loss, footprint size and manufacturing costs.

These secondary couplings take the form of a secondary iris 29. This secondary iris 29 may comprise a secondary connection portion between the two roofs 22 of the resonators connected by the secondary iris. As in the case of the connection portions, the secondary connection portions may comprise parts inclined with respect to the first axis so as to facilitate their additive manufacturing.

A secondary connection portion 29 is illustrated in FIG. 3b, where it connects a first resonator provided with an input port 31 and a third resonator provided with an output port 31.

The cross-section of a secondary iris 29 may be different from the cross-section of a main iris 24. The cross-section of a secondary iris is, for example, rectangular (the longest side of the rectangle being placed parallel or perpendicular to the first z axis).

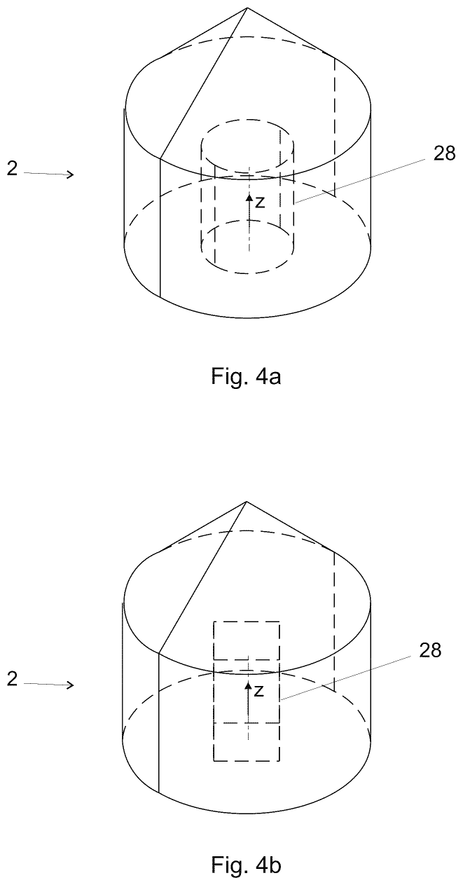

Another embodiment of a filter in which the resonators are arranged non-coaxially is illustrated in FIGS. 5a and 5b. Several resonators 2 designed according to the square base model are placed in a matrix, so that each resonator has at least two lateral faces contiguous with other resonators. Main irises 24 comprising connection portions 25 connect the resonators 2 so as to form a propagation path for an electromagnetic wave in the filter 1. In FIG. 5b, for example, an electromagnetic wave may enter the filter 1 via port 31 of the rightmost resonator 2, then propagate 90° counter-clockwise to a second resonator 2 (bottom in FIG. 5b) via a main iris, then propagate 90° clockwise to a third resonator 2 (left in FIG. 5b) via a main iris, then propagate 90° clockwise to a fourth resonator 2 (top in FIG. 5b) via a main iris, and finally propagate 90° counter-clockwise out of the filter through port 31 of the fourth resonator.

As illustrated in FIGS. 5a and 5b, the first and fourth resonators are additionally connected by a secondary iris 29 comprising a secondary connection portion 30. The cross-section of the secondary iris 29 differs from the cross-section of the main irises so as to improve filtering. In this embodiment, the secondary iris 29 has a square cross-section, one of the diagonals of which is parallel to the first z axis.

Although the geometry of the resonators allows the filter to be arranged in a non-coaxial manner, it is nevertheless possible to obtain a filter in which all the resonators 2 are aligned on the same axis of propagation of an electromagnetic signal, as illustrated for example in FIG. 2a.

In a particular embodiment, the waveguide filter of the present invention comprises at least four resonators, one of which resonators is connected to at least three separate resonators via main irises 24. Such a configuration makes it possible, in particular, to obtain a filter having several resonator branches, or in other words, a filter having, for example, one input port and several output ports or several input ports and one output port. This makes it possible to create combline waveguide filters with, for example, a power divider or polarizer function.

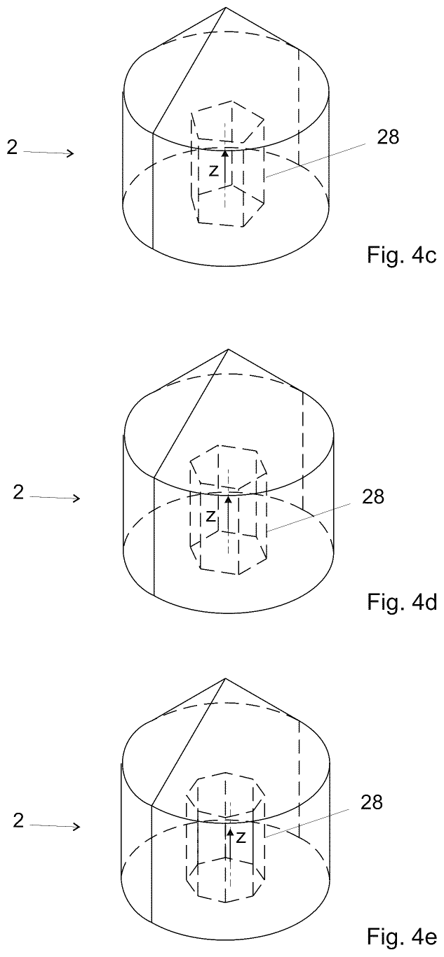

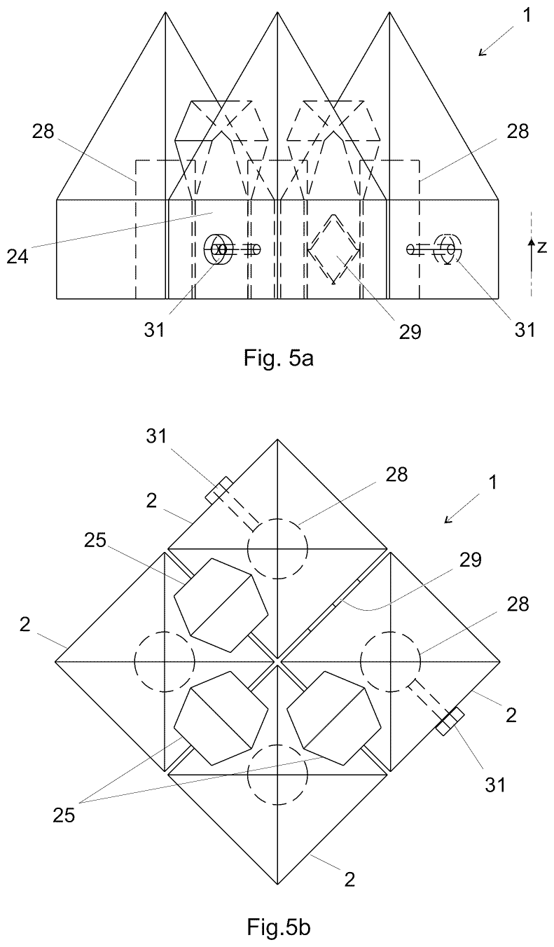

FIG. 6a shows a combline waveguide filter 1 in which at least one of the resonators 2 (the third counting from the left of the figure) is connected to three other resonators. Thus, the resonator 2 located to the left of the filter in FIG. 6a has a port 31 for input of an electromagnetic signal into the filter and the two resonators located to the right of the filter in FIG. 6a each have a port 31 for output of the electromagnetic signal out of the filter.

FIG. 6b illustrates a further embodiment of the invention in which a first resonator on the left of the figure has an input port 31 for an electromagnetic signal into the filter 1 and propagates the signal into two separate resonators via main irises 24. A final resonator on the right of the diagram receives two electromagnetic signals via main irises and propagates them outside the filter via an output port 31.

At least one resonator of the filter may comprise a polarizer and/or a septum so as to split and/or combine one or more electromagnetic signals. Other standard passive RF components may also be combined with the filter without departing from the scope of the present invention.

The present invention also relates to a method of manufacturing a waveguide filter as described above.

### LIST OF REFERENCE NUMERALS

1 Combline waveguide filter
2 Resonator
20 Cavity
21 Flat base
22 Roof
23 Single point
24 Main iris
25 Portion of connection
26 First lateral portion
27 Second lateral portion
28 Post
29 Secondary iris
30 Secondary connection section
31 Coaxial port
Z First axis
x Propagation axis

What is claimed is:

1. A combline waveguide filter obtained by metal additive manufacturing, comprising at least two resonators interconnected by main irises,
each resonator comprising a cavity with a first axis,
each cavity being delimited in particular by a flat base extending perpendicularly to the first axis,
wherein each cavity is further delimited by a roof converging towards a single point.

2. A waveguide filter according to claim 1, wherein each roof comprises a first lateral portion adjacent and perpendicular to the planar base and a second lateral portion converging towards the single point.

3. Waveguide filter according to claim 1, wherein each resonator has rotational symmetry about the first axis.

4. Waveguide filter according to claim 1, wherein each flat base is circular or polygonal with at least three sides, preferably circular, square, pentagonal, hexagonal or octagonal.

5. A waveguide filter according to claim 1, wherein each resonator further comprises a post rising from the planar base parallel to the first axis.

6. Waveguide filter according to claim 5, herein at least one post is formed integrally with a flat base of a resonator.

7. Waveguide filter according to claim 6, wherein the post of each resonator has a circular or polygonal with at least three sides cross-section, preferably a circular, square, pentagonal, hexagonal or octagonal cross-section.

8. Waveguide filter according to claim 5, wherein the post is helical and extends along the first axis.

9. Waveguide filter according to claim 8, wherein a diameter of the post is variable along the first axis.

10. Waveguide filter according to claim 1, wherein a roof of at least one resonator comprises a projecting part extending towards the interior of the cavity of the at least one resonator parallel to the first axis.

11. Waveguide filter according to claim 1, wherein at least one main iris comprises a connection portion not parallel to the plane base, the connection portion extending between two resonators connected by the at least one main iris.

12. Waveguide filter according to claim 11, wherein the connection portion connects said single points of the resonators connected by said at least one main iris.

13. Waveguide filter according to claim 1, wherein at least one resonator comprises several main irises which are not arranged coaxially.

14. Waveguide filter according to claim 1, wherein it comprises at least three resonators connected consecutively by said main irises, a first and a second resonator being connected together by a secondary iris.

15. Waveguide filter according to claim 14, wherein the secondary irises have a different cross-section from the main irises.

16. Waveguide filter according to claim 13, wherein at least one said secondary iris comprises a secondary connection portion extending between the resonators connected by the at least one said secondary iris.

17. Waveguide filter according to claim 1, wherein the main irises of the resonators are arranged coaxially along an axis of propagation of an electromagnetic signal.

18. Waveguide filter according to claim 1, wherein it comprises at least four resonators, one of the at least four resonators being connected to at least three separate resonators.

19. Waveguide filter according to claim 1, wherein at least one resonator comprises a polarizer and/or a septum.

20. Method of manufacturing a combline waveguide filter according to claim 1, comprising the additive manufacturing of at least two resonators and the main irises connecting the resonators.
